(19) United States
(12) Patent Application Publication
(10) Pub. No.: US 2007/0060021 A1
(43) Pub. Date: Mar. 15, 2007

(54) Device for the production of comb honey

(75) Inventors: Ian B. Bigham, Ontario (CA); Andreas W. Sperlich, Ontario (CA)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: BEE-O-SPHERE TECHNOLOGY, St. Williams, ON (CA)

(21) Appl. No.: 10/538,814

(22) PCT Filed: Dec. 12, 2003
(86) PCT No.: PCT/IB03/06496

§ 371 Date: Jun. 16, 2006

Related U.S. Application Data
(60) Provisional application No. 60/433,495, filed on Dec. 13, 2002.

(51) Int. Cl. A01K 47/02

(52) U.S. Cl. 449/43

(57) ABSTRACT

A device for the collection and packaging of comb honey comprises a frame structured to fit within a honey collection section of a beehive, such as a beehive super. The frame has a plurality of cavities for collecting the honey. The frame has separation structures between the cavities to facilitate separation of the cavities from the frame. In another embodiment, the frame has opposing sides and a plurality of outwardly facing cavities in each of the sides for collecting the honey. In another embodiment, the frame comprises first and second frame halves on opposing sides of the frame. Each of the frame halves includes a backside that is enclosed by the frame to keep bees away from the backside.

### BACKGROUND OF THE INVENTION

This invention relates in general to the apiary industry, and in particular to a device for the collection and packaging of comb honey.

The apiary industry practices the art of bee keeping, which involves the raising and breeding of honeybee populations. The bees are housed in beehives, which can take many shapes and forms. In North America, the most popular hive design is that patented by Langstroth in 1852. Honey bees, as a means of storing food in the hive, produce honey in the form of comb honey. Comb honey is a matrix of six-sided wax cavities that are filled with the nectar collected by the bees from flowers. When the moisture content of the flower nectar is reduced to an acceptable level by evaporation (approx. 17%) it becomes honey and is sealed off in the cavity with a capping of wax. The bees will build this comb to maintain the bee space, which is a gap big enough for two bees to pass each other back to back. This bee space is approximately ⅜″ across. If the bees encounter a gap that is equal to or smaller than ⅜″ but larger than approximately 3/16″ (which is enough space for one bee) then they will not build comb. If the gap is smaller than 3/16 then the bees will close up the gap with comb and or propolis. This becomes evident to the beekeeper when he tries to separate the hive sections and remove frames from inside the hive—everywhere there is contact between parts of the hive there is propolis and or burr comb gluing everything together.

The Langstroth type of hive consists of a base, a brood chamber, one or more honey supers, and a cover. The base is a flat rectangular board with raised edges on three sides. The brood chamber is an open-ended box of rectangular section 20″×16″ about 10″ deep that sits on the base open at top and bottom. On top of the brood chamber are the honey supers that are the same as the brood chamber but can vary in depth. The cover sits on top of the last honey super as a roof for the hive. Removable frames hang from their top bars supported on a rabbet cut in the front and back sides of the brood chamber and/or honey super.

The honey, produced by the bees in the hive, is sold to the consumer in two main forms. The first being extracted honey, where the honey is separated from the wax comb produced by the bees. The second being comb honey, where the honey is retained in the wax comb. There are two ways that the comb honey is packaged for sale. One method is to cut the comb honey, produced in frames in the hive, and package these comb shapes in suitable containers. This method can be quite messy and produce a significant amount of reject comb that must be dealt with in another way. The other method is to provide the bees with a package in the hive that they can fill with comb honey and thus remove the necessity of cutting the comb and reduce handling for the beekeeper. These packages, in the past, have been used in varying shapes and sizes and arrangements that have required special frames and/or super designs for them to be presented to the bees in the proper way (e.g., U.S. Pat. Nos. 4,329,749, 4,435,865 and 4,639,962 to Hogg; U.S. Pat. No. 4,185,343 to Ross; and U.S. 4,195,379 to Krasnik).

These packages also present joints or crevices to the bees when the packages are assembled as a group in the hive. Bees will fill or seal up any perceived gap or joint or crevice that they find within the hive with wax and/or propolis in their attempts to protect the integrity of the hive. Therefore, any outside surface of the packaging that forms a perceived gap and is exposed to the bees will then have propolis or wax attached to it, which will then require removal or cleaning before sale. This propolis and wax also tends to glue everything together, which can make separation of the individual packages difficult as well.

### SUMMARY OF THE INVENTION

This invention relates -to a device for the collection and packaging of comb honey. The device comprises a frame structured to fit within a honey collection section of a beehive, such as a beehive super. The frame has a plurality of cavities for collecting the honey. The frame has separation structures between the cavities to facilitate separation of the cavities from the frame.

In another embodiment, the frame has opposing sides and a plurality of outwardly facing cavities in each of the sides for collecting the honey.

In another embodiment, the frame comprises first and second frame halves on opposing sides of the frame. Each of the frame halves has a plurality of outwardly facing cavities for collecting the honey. Each of the frame halves includes a backside that is enclosed by the frame to keep bees away from the backside.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of frame half A.

FIG. 2 is a perspective view of frame half B.

FIG. 3 is a perspective view of frame half A and frame half B assembled to make a complete frame C.

FIG. 4 is a perspective view in detail of the assembled frame.

FIG. 5 is a perspective view of an individual cavity and lid.

FIG. 6 is a perspective view of the cavity assembled with the lid to make a package.

FIG. 7 is an enlarged perspective view of an attachment structure of the frame.

FIG. 8 is an enlarged perspective view of attachment structure after being riveted.

FIG. 9 is a side elevational view of the frame inside a beehive super.

FIG. 10 is a perspective view of a plurality of frames side by side inside the super.

### DETAILED DESCRIPTION OF THE PREFERRED EMBODIMENT

The present invention provides the bees with a frame that they can fill with comb honey. This frame does not require special or modified supers and provides a simple economical method for the beekeeper to collect and package the honey for sale.

The frame is structured to fit within a honey collection section of a beehive. The honey collection section can be a honey super, a brood chamber, or any other beehive section adapted for collecting comb honey.

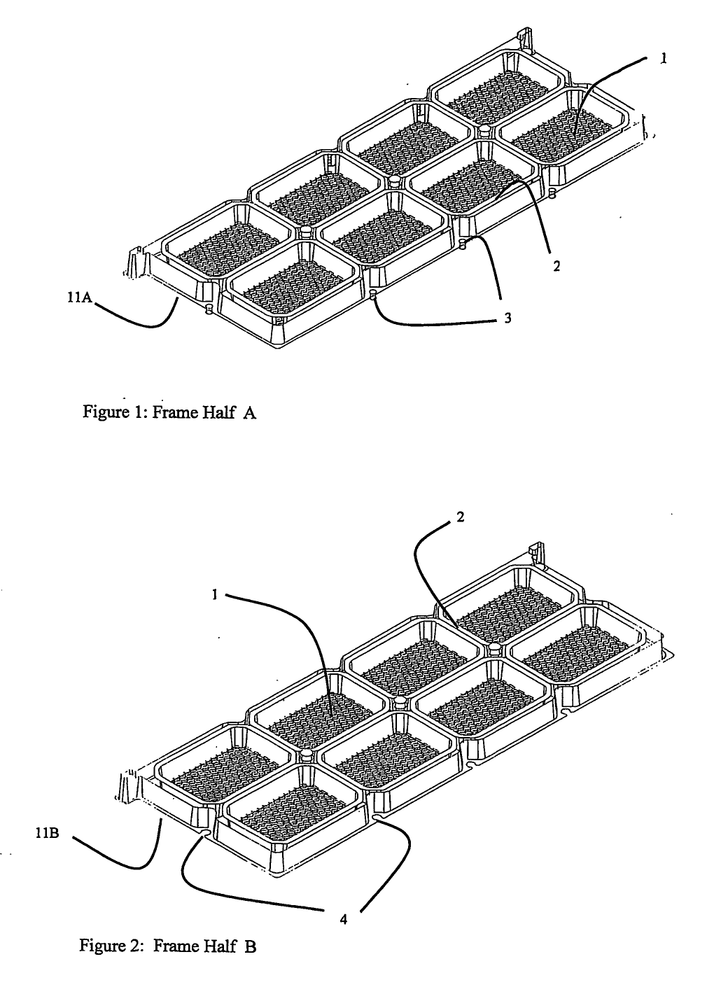

As shown in FIGS. 1 and 2, the frame has a plurality of cavities 1 for collecting the honey. Any desired number of cavities can be included in the frame. In the illustrated embodiment, the frame comprises frame half A and frame half B on opposing sides of the frame, and each frame half has eight cavities 1. The cavities open outwardly and provide a space for the bees to build their comb honey. The cavities can have any suitable size and shape. Preferably, the depth of the cavities is approximately the same as the width of each frame half. Preferably, the cavities have a honeycomb pattern on their bottom surface to provide a foundation for the bees to build their comb on.

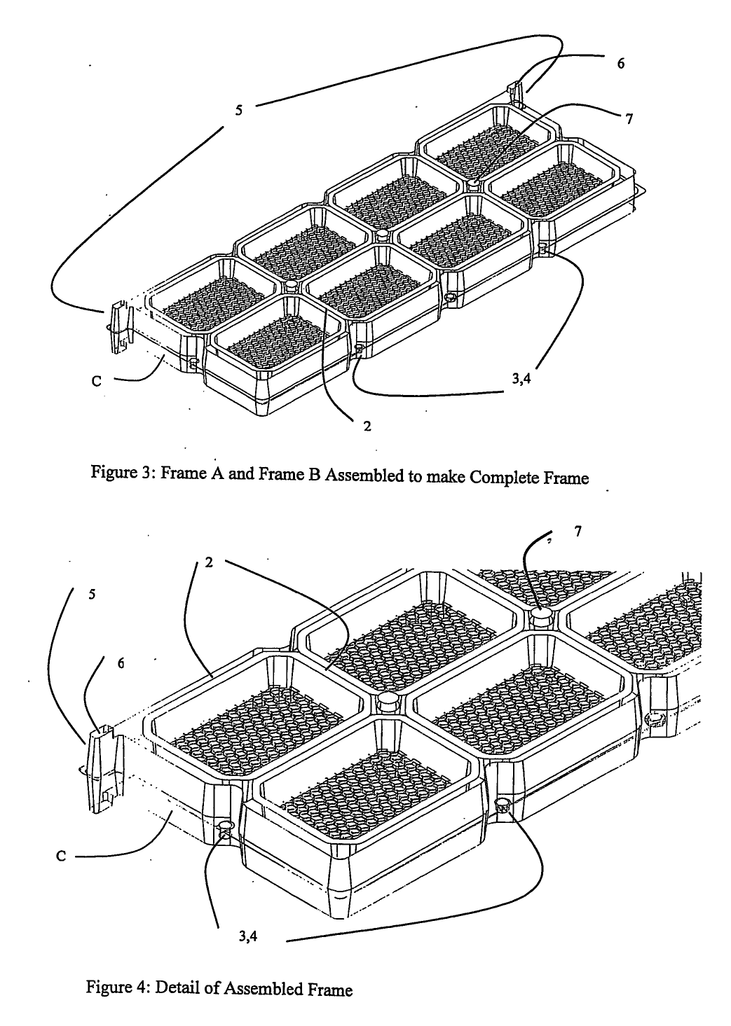

As shown in FIG. 3, the frame halves A and B are attached together to make a complete frame C. The frame halves can have any suitable construction and can be made from any suitable material(s). In one embodiment, each frame half is a sheet of plastic that has been thermoformed to form the cavities. Alternatively, the frame halves could be injection or blow molded from a suitable thermoplastic.

In the illustrated embodiment, the frame has separation structures between the cavities to facilitate separation of the cavities from the frame after the bees have built, filled and capped the comb. Any suitable separation structures can be used. As shown in FIGS. 1 to 4, the frame includes a surface around the edge of each cavity, and the surface has discontinuous cuts 2 that extend around the cavity to aid in separation of the cavity from the frame. The discontinuous cuts can be produced by any suitable method. In one embodiment, the cuts are produced by putting small nicks in the trimming die that leave small uncut segments at several positions around each cavity. These segments serve to retain the cavities in the frame halves and maintain the integrity of the whole.

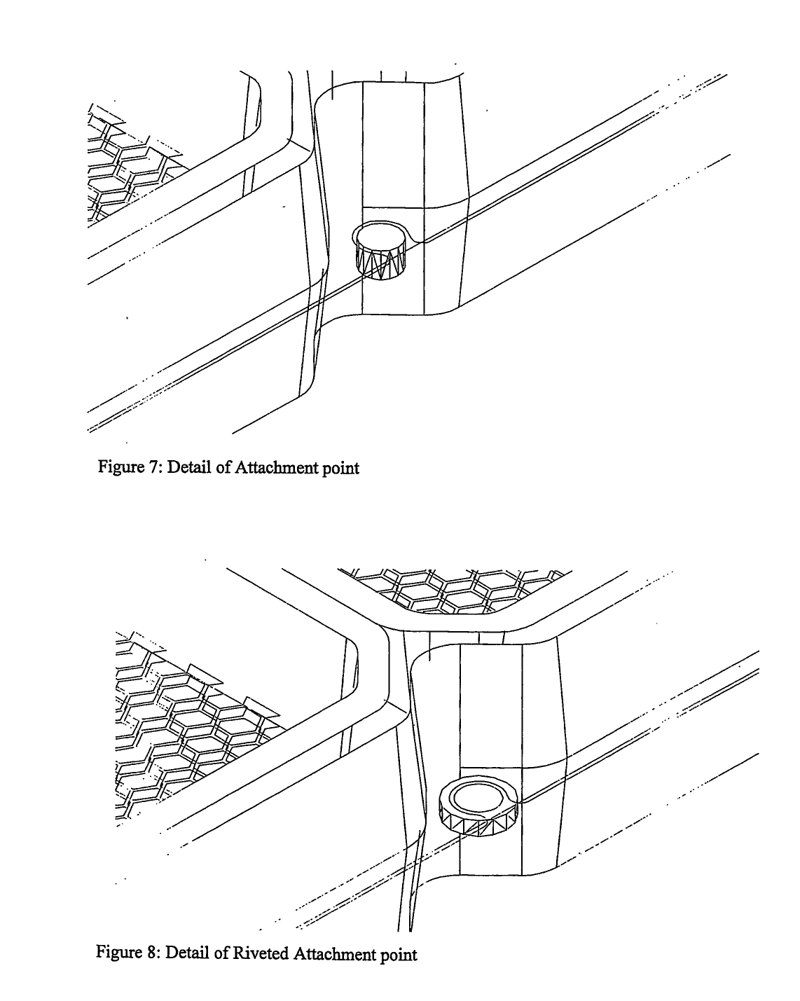

When the frame comprises first and second frame halves, preferably the frame includes at least one attachment structure for attaching the frame halves together. A preferred attachment structure is structured so that the frame halves can be detached from each other after collection of the honey. Any suitable attachment structure(s) can be used. In the embodiment shown in FIGS. 1 to 4, the two frame halves are fixed to each other at eight locations around the frame edge. Frame A has a cylindrical hollow pin 3 formed at each attachment and Frame B has a corresponding keyhole slot 4. When the two halves are placed back to back the pins of frame A fit through the keyhole slots of frame B as shown in FIG. 7. The two halves are then riveted together by crushing the pins as shown in FIG. 8. A pair of pliers or other suitable means can be used to crush the pins and form the rivet. After collection of the honey, the rivets can be removed with a pliers or other suitable means to allow the frame halves to be detached from each other.

As shown in FIGS. 1 and 2, the frame halves A and B include backsides 11A and 11B, respectively. The backsides become the outside surfaces of the packages for the collected honey. Preferably, the frame is constructed in such a way that the backsides are enclosed by the frame to keep bees away from the backsides. This minimizes the sites that the bees will feel obligated to seal up and thus greatly reduces the amount of package cleaning required before sale. In the illustrated embodiment, the backsides are held tightly against each other in the assembled frame to enclose the backsides.

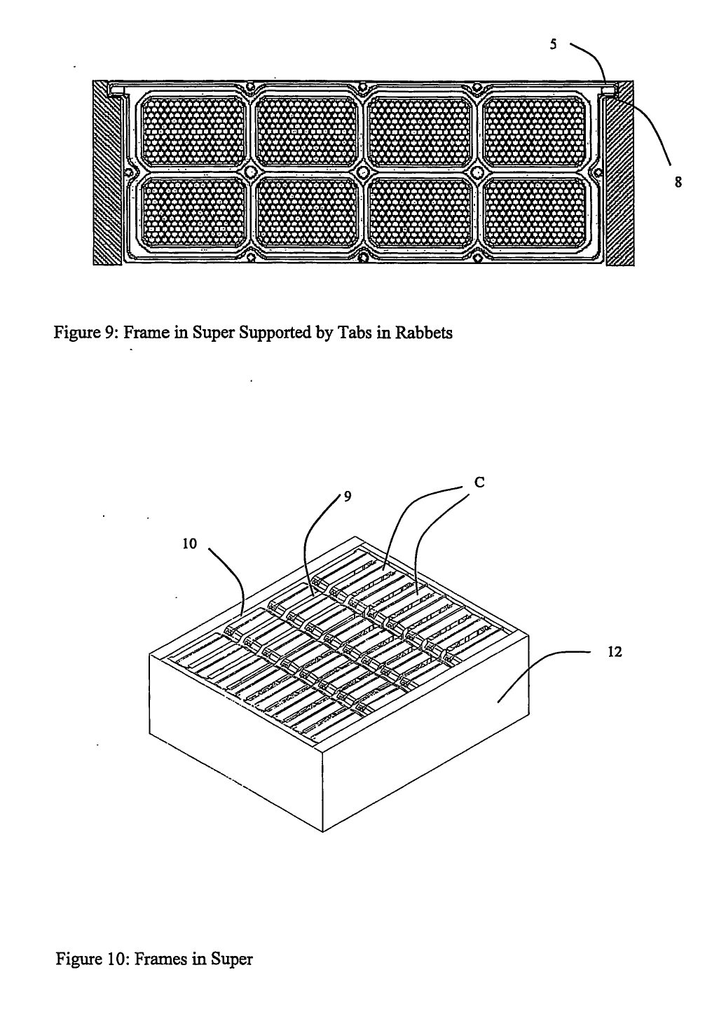

Preferably, the frame includes one or more support structures to facilitate the support of the frame inside the honey collection section. In the embodiment shown in FIGS. 3, 4 and 9, the frame has a tab 5 at each end of the top edge of the frame. These tabs serve to support the frame on the rabbets 8 (FIG. 9) in the top edge of the honey super 12. Eight of these frames will fit in a standard 6 5/8 ″ Langstroth honey super 12 as shown in FIG. 10.

The preferred frame also includes spacing structures to maintain the proper bee spacing between the frames, and between the frames and the sides of the honey collection section. Any suitable structures can be used for this purpose. In the embodiment shown in FIGS. 3, 4 and 10, the proper bee spacing between the frames is maintained with the use of buttons 6 and 7 that protrude from the sides of the frame. As shown in FIG. 10, when the frames are in place in the super 12 the buttons butt against each other between adjacent frames C to maintain a gap 9 of a suitable size, typically about ⅜″. The frames closest to the sides of the super usually maintain a smaller gap 10 between the super and the frame with the same buttons, typically a gap of about 3/16″ at a minimum.

The frame can be sized and shaped in any suitable manner such that multiple frames fit within the honey collection section in a side by side fashion. In the embodiment shown in FIG. 10, eight frames C fit within the super 12. Preferably, the frame has a length, from end to end, equal to the inside length of the honey collection section less an allowance for bee space between the frame ends and the honey collection section. The preferred frame has a height, from top to bottom, equal to the inside height of the honey collection section less an allowance for bee space between the frame bottom and the honey collection section. Preferably, the frame has a width, from side to side, such that a plurality of the frames will fill the honey collection section, with an allowance for bee spaces between the frames, and between the frames and the sides of the honey collection section.

In a particular embodiment, the frame is designed to fit in a standard Langstroth 6⅝″ super, and the frame is approximately 19″ long from tab end to tab end and is approximately 6.5″ wide and has a thickness excluding bee space buttons of approximately 1.5″. There are other possibilities for changing the dimensions of the frame. Another example would be a frame that would fit in a full size honey super where the frame width would be approximately 12″ with the other dimensions similar. Another example would be to increase the thickness of the frames and hence the depth of the individual cavities while at the same time reducing the number of frames per super. For the existing frame size the number of cavities per side could be reduced to make larger packages or increasing the number of cavities will effectively reduce the size of the packages. Smaller packages may be desirable for the hospitality industry as single serving units.

When the frames have been assembled and placed in the super, the super is then put on a suitable hive colony and left to the bees to build their comb. After a suitable time which depends on the strength of the hive colony and the honey flow, when the cavities are filled and capped, a bee escape is placed between the super and the hive to remove the bees from the super. The super can then be brought back to the honey house for the final packaging.

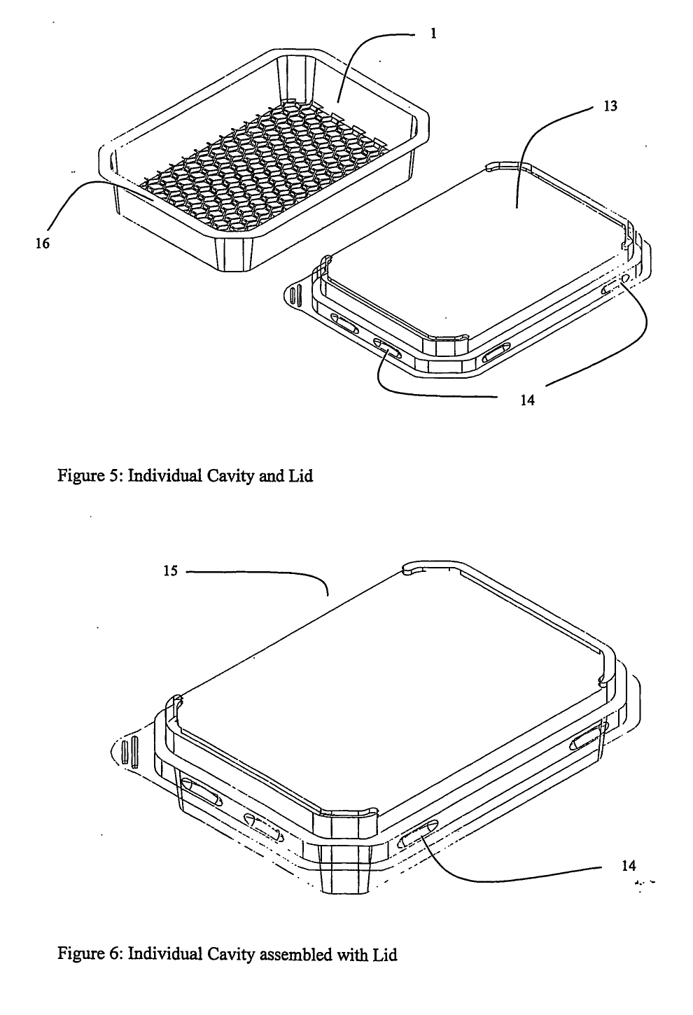

Back at the honey house the frames, now filled with comb honey, are removed from the super one at a time. Each frame is separated into its two halves again and each half is laid flat on the table, comb side facing up. The individual cavities 1, see FIG. 5, can then be separated from the frame halves, see FIGS. 1 and 2, by cutting the segments in the discontinuous die cuts with a sharp knife or other means. Each cavity 1 can then be fitted with a lid 13 as in FIG. 6 to complete the package 15 that encloses the collected comb honey. Preferably, the package includes means for mechanically fastening the lid to the cavity. In the illustrated embodiment, the lid 13 includes indents 14 that cooperate with the rim 16 of the cavity 1 to hold the lid on the cavity.

The completed package can have any suitable size and shape. In one embodiment, the package is approximately 4.5″ long by 3.25″ wide by 0.75″ deep and will hold approximately 4.5 ounces (130 gms) of comb honey. Although the illustrated package is rectangular in shape, other possible shapes of packages could be hexagonal, octagonal, circular or triangular to name a few.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A device for the collection and packaging of comb honey comprising a frame structured to fit within a honey collection section of a beehive, the frame having a plurality of cavities for collecting the honey, and separation structures to facilitate separation of the cavities from the frame.

2. A device according to claim 1 wherein the separation structures comprise discontinuous cuts in the frame.

3. A device according to claim 1 wherein the frame is formed from plastic.

4. A device according to claim 1 further comprising a lid structured to combine with the separated cavity to create a package that encloses the collected honey.

5. A device according to claim 4 wherein the package includes means for mechanically fastening the lid to the cavity.

6. A device according to claim 1 wherein the frame includes spacing structures to maintain the proper bee spacing between the frame and adjacent frames in the honey collection section.

7. A device for the collection and packaging of comb honey comprising a frame structured to fit within a honey collection section of a beehive, the frame having opposing sides and a plurality of outwardly facing cavities in each of the sides for collecting the honey.

8. A device according to claim 7 wherein the frame includes spacing structures to maintain the proper bee spacing between the frame and adjacent frames in the honey collection section.

9. A device according to claim 8 wherein the spacing structures comprise raised buttons on the side surfaces of the frame.

10. A device according to claim 7 wherein the frame includes one or more support structures to support the frame within the honey collection section.

11. A device according to claim 10 wherein the support structures comprise tabs structured to engage rabbets of the honey collection section.

12. A device according to claim 7 wherein the frame is formed from plastic.

13. A device according to claim 7 wherein the cavities have a honey comb pattern to provide a foundation for the bees to build the comb on.

14. A device according to claim 7 wherein the frame has a length, from end to end, equal to the inside length of the honey collection section less an allowance for bee space between the frame ends and the honey collection section.

15. A device according to claim 7 wherein the frame has a height, from top to bottom, equal to the inside height of the honey collection section less an allowance for bee space between the frame bottom and the honey collection section.

16. A device according to claim 7 wherein the frame has a width, from side to side, such that a plurality of the frames will fill the honey collection section, with an allowance for bee spaces between the frames, and between the frames and the sides of the honey collection section.

17. A device for the collection and packaging of comb honey comprising a frame structured to fit within a honey collection section of a beehive, the frame comprising first and second frame halves on opposing sides of the frame, each of the frame halves having a plurality of outwardly facing cavities for collecting the honey, and each of the frame halves including a backside that is enclosed by the frame to keep bees away from the backside.

18. A device according to claim 17 wherein the frame includes at least one attachment structure for attaching the frame halves together, and the attachment structure is structured so that the frame halves can be detached from each other after collection of the honey.

19. A device according to claim 17 wherein the frame has separation structures to facilitate separation of the cavities from the frame.

20. A device according to claim 17 wherein the frame includes spacing structures to maintain the proper bee spacing between the frame and adjacent frames in the honey collection section.
